(19) United States
(12) Patent Application Publication
(10) Pub. No.: US 2016/0003267 A1
(43) Pub. Date: Jan. 7, 2016

(54) Electronic Control of Actuator Force and Torque with an Independent Metering Valve

(71) Applicant: Caterpillar Inc., Peoria, IL (US)

(72) Inventors: Matthew Beschorner, Plainfield, IL (US); Brett Janson, Hanna City, IL (US); Anthony Sanders, Chillicothe, IL (US)

(21) Appl. No.: 14/321,047

(22) Filed: Jul. 1, 2014

(51) Int. Cl. F15B 13/02; E02F 3/30; E02F 3/42; F15B 1/26; F15B 15/14

(52) U.S. Cl. CPC F15B 13/024; F15B 1/26; F15B 15/14; E02F 3/425; E02F 3/30; F15B 2211/205; F15B 2211/40576

(57) ABSTRACT

A hydraulic system includes one or more sensors configured to measure a pressure at least one input or end of a hydraulic actuation device, such as a cylinder for example. A control module can be operatively coupled to the sensors and at least one metering valve. The control module can selectively open the metering valve when the pressure at one of the ends of the cylinder reaches a first pressure threshold to control the force on the cylinder rod, to permit flow from the end of the cylinder to the tank.

### TECHNICAL FIELD

The disclosure relates generally to a hydraulic control system having high-pressure and force control, and, more particularly, to a hydraulic control system having an independent metering valve with electronic pressure and force control.

### BACKGROUND

Machines, such as excavators, loaders, dozers, motor graders, and other types of heavy equipment use one or more actuators supplied with hydraulic fluid from a hydraulic source to accomplish a variety of tasks. These actuators are typically controlled based on an actuation of an operator interface device. For example, an operator interface device such as a joystick, a pedal, or another suitable operator interface device may be movable to generate a desired movement of an associated hydraulic actuator. When an operator moves the interface device, the machine operates the hydraulic actuator to move.

In some situations, it may be possible for a pressure of the fluid supplied to the actuator(s) to exceed a desired level during the above described actuation. This over-pressure situation can occur, for example, when work tool movement becomes stalled (e.g., when the work tool strikes against an immovable object). In these situations, the actuator or other components of the associated system can malfunction or be damaged.

Conventionally, over-pressure situations are dealt with by a mechanical relief valve associated with the system that can open when system pressure exceeds a desired pressure. High-pressure fluid from the system is then directed through the open mechanical relief valve and dumped into a low-pressure tank, thereby reducing the pressure of the system. Although effective, this strategy can be inefficient, as the dumped fluid contains significant energy that is wasted. Further, some hydraulic systems may experience frequent pressure spikes or high flows, such as when a load is applied to the implement. Frequent use of the mechanical relief valve can ultimately cause the mechanical relief valve to break or fail.

U.S. Pat. No. 5,813,226 describes a hydraulic system in which over-pressure situations are handled with an arrangement of metering valves. The hydraulic system described in U.S. Pat. No. 5,813,226 accomplishes pressure control without separate line reliefs. In particular, U.S. Pat. No. 5,813,226 describes a hydraulic system 10 that includes a source of pressurized fluid 12, such as a variable displacement pump 14, first and second hydraulic circuits 16, 18, an electrically controlled bypass valve 19, an electronic controller 20, and a reservoir 22. Thus, mechanical relief valves do not fail, but the system may be susceptible to extreme overpressure situations. Such overpressure situations may include situations that are caused by various external forces on a cylinder.

Accordingly, there is a need for a device and process to reduce use of mechanical relief valves in overpressure situations, which may be caused by various external forces.

### SUMMARY

In one aspect, the disclosure describes a hydraulic system that includes a cylinder having a first end and a second end opposite the first end. The hydraulic system further includes a hydraulic pump hydraulically connected to at least the first end of the cylinder to facilitate movement of the cylinder. The hydraulic system further includes a first mechanical relief valve hydraulically connected to the first end of the cylinder, a first valve hydraulically connected to the first end of the cylinder and a tank, and a first sensor configured to measure a pressure at the first end of the cylinder. A control module can be operatively coupled to the first sensor and the first valve. The control module can be configured to selectively open the first valve when the pressure at the first end of the cylinder reaches a first pressure threshold, to permit fluid to flow from the first end of the cylinder to the tank.

In another aspect, the disclosure describes a work machine, such as a mining shovel for example, that includes a boom assembly, a dipper movably connected to the boom assembly, and a cylinder operably connected to the dipper. The cylinder has a first end and a second end opposite the first end. The work machine further includes a hydraulic pump hydraulically connected to at least the first end of the first cylinder to facilitate movement of the cylinder, a first mechanical relief valve hydraulically connected to the first end of the cylinder, a first valve hydraulically connected to the first end of the cylinder and a tank, and a first sensor configured to measure a pressure at the first end of the cylinder. A control module can be operatively coupled to the first sensor and the first valve. The control module can be configured to selectively open the first valve when the pressure at the first end of the cylinder reaches a first pressure threshold, to permit fluid to flow from the first end of the cylinder to the tank.

In yet another aspect, a method of operating a hydraulic system is disclosed. The hydraulic system may include: 1) a cylinder having a first end and a second end opposite the first end, the cylinder being movable between a retracted position and an extended position; 2) a hydraulic pump selectively hydraulically connected to at least the first end of the first cylinder to facilitate movement of the cylinder; 3) a first mechanical relief valve hydraulically connected to the first end of the cylinder; 4) a first valve hydraulically connected to the first end of the cylinder and a tank; 5) a first sensor configured to measure a pressure at the first end of the cylinder; and 6) a control module operatively coupled to the first sensor and the first valve. The method may include determining that the pressure at the first end of the cylinder exceeds a first pressure threshold. The method may further include opening the first valve such that fluid flows from the first end of the cylinder to the tank, and opening the first mechanical relief valve when the pressure at the first end of the cylinder reaches a second pressure threshold such that fluid flows from the first end of the cylinder to the tank, wherein the second pressure threshold is greater than the first pressure threshold.

In yet another aspect, the disclosure describes a hydraulic system that includes a hydraulic actuation device having a first input and a second input. The hydraulic actuation device may be movable in response to fluid being applied to the first input or the second input. The hydraulic actuation device may include a motor, a cylinder, or the like. The hydraulic system further includes a hydraulic pump hydraulically connected to at least the first input of the hydraulic actuation device to facilitate movement of the hydraulic actuation device. The hydraulic system further includes a first mechanical relief valve hydraulically connected to the first input of the hydraulic actuation device, a first valve hydraulically connected to the first input of the hydraulic actuation device and a tank, and a first sensor configured to measure a pressure at the first input of the hydraulic actuation device. A control module can be operatively coupled to the first sensor and the first valve. The control module can be configured to selectively open the first valve when the pressure at the first input of the hydraulic actuation device reaches a first pressure threshold, to permit fluid to flow from the first end of the hydraulic actuation device to the tank.

### BRIEF DESCRIPTION OF THE DRAWINGS

FIG. 1 is a perspective view that illustrates an exemplary machine that incorporates aspects of the disclosure.

FIG. 2 is a schematic representation of a hydraulic system including a control valve assembly for the exemplary machine of FIG. 1, according to an exemplary aspect of the disclosure.

FIG. 3 is a schematic representation of the hydraulic system depicted in FIG. 2, wherein the hydraulic system is coupled to a motor in accordance with an exemplary aspect of the disclosure.

FIG. 4 is a flow diagram that illustrates a method that may be performed by the machine depicted in FIG. 1 in accordance with an exemplary aspect of this disclosure.

### DETAILED DESCRIPTION

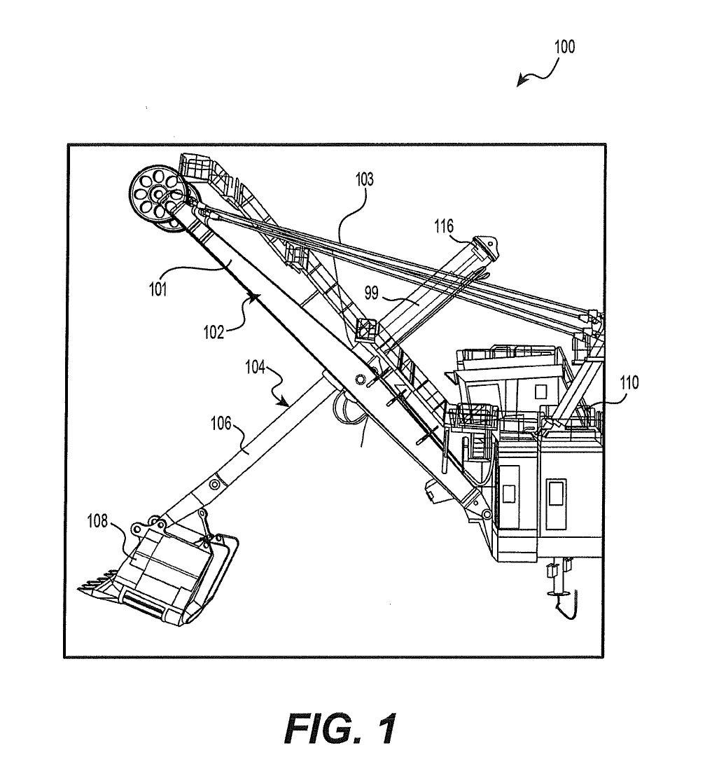

Referring to the drawings, wherein like reference numbers refer to like elements, FIG. 1 illustrates an exemplary work machine 100. The work machine 100 may be a fixed or mobile machine that performs some type of operation associated with an industry such as mining, construction, farming, or any other industry known in the art. For example, the work machine 100 may be an earth moving machine such as a dozer, a loader, a backhoe, an excavator, a motor grader, a dump truck, or any other earth moving machine. The work machine 100 may also include a generator set, a pump, a marine vessel, or any other suitable operation-performing work machine. The specific machine illustrated in FIG. 1 may be referred to as a mining shovel 100 and, more specifically, the work machine 100 may be an electric rope shovel.

Referring to FIG. 1, in accordance with the illustrated aspect, the mining shovel 100 may include a boom assembly 102 that supports a dipper assembly 104. The dipper assembly 104 may include a crowd or dipper arm 106 and a dipper or bucket 108 that may be attached to the dipper arm 106. The dipper arm 106 may be pivotably connected to the boom assembly 102 such that the dipper arm 106 is configured to move relative to the boom assembly 102. The boom assembly 102 may include a boom 101 and a plurality of cables or ropes 103 that are coupled to the boom 101 such that the ropes 103 may suspend the boom 101 at various angles with respect to the ground. The dipper 108 may be coupled to the dipper arm 106 such that the dipper 108 moves when the dipper arm 106 moves. As shown, the dipper 108 may be configured to hold earth materials or any other load materials, such as rock, dirt, overburden, ore, or the like. As used herein, material that can be moved or mined by the dipper assembly 104 can be collectively referred to as mining material. Mining material can be loaded into the dipper 108 by moving the dipper arm 106. The dipper arm, and thus the dipper assembly 104, may further include a hydraulic cylinder 99 that can apply a force to the dipper 108. The hydraulic cylinder 99 is movable between a retracted position and an extended position. For example, the hydraulic cylinder 99 may be moved into an extended position to push the dipper 108 into a surface, such as a bank of mining material for example.

While aspects are described herein with reference to the mining shovel 100, it will be appreciated that any machine, vehicle, device or the like can use one or more hydraulic cylinders or hydraulic actuated motors with a high-pressure and force control according to aspects of the disclosure.

The dipper arm 106, and thus the dipper 108, can move in response to an operator input device 110 that is part of the mining shovel 100. For instance, an operator of the mining shovel 100 may provide an input by pressing a button, moving a joystick, or otherwise interacting with the operator input device 110. In an exemplary aspect, the operator input device 110 is coupled to a control module 112 such that the control module 112 can receive inputs from the operator input device 110. The control module 112, which can also be referred to as an electronic controller 112, can be further coupled to one or more components within the mining shovel 100, as described below.

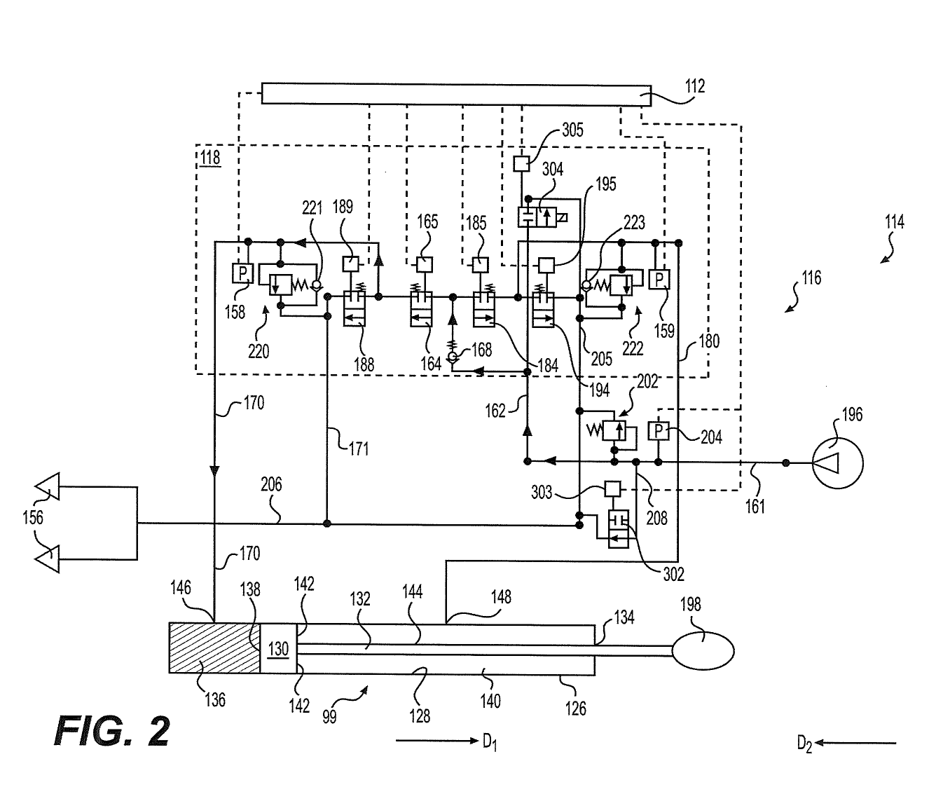

FIG. 2 is a schematic view of a hydraulic system 114 that may be included as part of the machine 100 depicted in FIG. 1, in accordance with an exemplary aspect of the disclosure. Referring FIG. 2, the hydraulic system 114 may include a valve assembly 116, shown as an independent metering valve (IMV) assembly 116 in FIG. 2. The IMV assembly 116 may be fluidly coupled to the cylinder 99, as further described below. The IMV assembly 116 may be located at or near a top end of the dipper assembly 104, wherein the top end of the dipper assembly is opposite the dipper 108 (see FIG. 1). This arrangement is merely exemplary and other arrangements are contemplated as well. The IMV assembly 116 may include one or more IMV arrangements. In accordance with the illustrated aspect, the IMV assembly 116 may include a first IMV arrangement 118, though it will be appreciated that the IMV assembly can include any number of IMV arrangements as desired. The IMV assembly 116 can be hydraulically (fluidly) connected to the hydraulic cylinder 99. The hydraulic system 114 can further include a hydraulic pump 196 that is hydraulically connected to the IMV assembly 116 such that the IMV assembly 116 can control a flow of fluid between the hydraulic pump 196 and the hydraulic cylinder 99, as described further below with reference to FIG. 2. In accordance with the illustrated aspect, the hydraulic system 114 may include one pump 196, though it will be understood that the hydraulic system 114 can include any number of pumps as desired. The IMV assembly 116 can include one or more openings that fluidly connect the IMV assembly 116 to the cylinder 99.

With continuing reference to FIG. 2, the cylinder 99 may include a tube 126 that defines a cylinder bore 128 therein, and a piston assembly 130 disposed within the cylinder bore 128. The cylinder 99 further may include a rod 132 that is coupled to the piston assembly 130. As shown, the rod 132 may extend through the tube 126 at a seal 134. A head-end chamber 136, which can be referred to generally as the head-end 136, can be defined by a first face 138 of the piston assembly 130 and the cylinder bore 128. The rod-end chamber 140, which can also be referred to generally as the rod-end 140, can be defined by a second face 142 opposite the first face 138 of the piston assembly 130, the cylinder bore 128, and a rod surface 144 of the rod 132. Thus, cylinder 99 can include a first end and a second end that is opposite the first end. In some aspects, the first end can be a head-end and the second end can be a rod-end. In other aspects, the first end can be a rod-end and the second end can be a head-end. In general, it should be appreciated that the terms “first end” and “second end” may refer to any type of head-end or rod-end of the cylinder 99.

The head-end chamber 136 and the rod-end chamber 140 of the hydraulic cylinder 99 may be selectively supplied with pressurized fluid or selectively drained of fluid. The head-end chamber 136 can be selectively supplied with pressurized fluid or selectively drained of fluid via a head-end port 146 that can be coupled to the IMV assembly 116. The rod-end chamber 140 can be selectively supplied with pressurized fluid or selectively drained of fluid via a rod-end port 148 that can be coupled to the IMV assembly 116. The IMV assembly 116 can further be fluidly connected to one or more hydraulic pumps 196 and one or more hydraulic tanks 156. In an exemplary aspect, the IMV assembly 116 receives fluid from the hydraulic pump 196 and routes the fluid to the rod-end chamber 140 or the head-end chamber 136 of the cylinder 99 through one or more fluid paths, as necessary. The IMV assembly 116 can also return fluid from the hydraulic cylinder 99 and route the fluid to the hydraulic tank 156 for re-use. As further described below, the IMV assembly 116 can include one or valves that route fluid through the IMV assembly 116. In various exemplary aspects, the hydraulic system 114 includes the cylinder 99 and the IMV assembly 116 that is coupled to at least one end of the cylinder 99 such that the IMV system 116 can route fluid for powering the cylinder 99. In an exemplary aspect, the IMV assembly 116 can be mounted directly to the cylinder 99, though it will be appreciated that the IMV assembly 116 may be alternatively part of the mining shovel 100 as desired, such that the IMV assembly 116 can route fluid to the hydraulic cylinder 99.

The mining shovel 100 may include the hydraulic system 114 that, among other features, can monitor and control pressure within the hydraulic cylinder 99. For example, the control module 112 may cause an actuator 198 of the hydraulic cylinder 99 to retract or extend. For example, the control module may be coupled to one or more pressure sensors, such as sensors 158, 159, and 204. The control module 112 may receive pressure readings from the sensors 158, and 159, and 204. Based on the pressure readings, the control module 112 can control the flow of fluid in the hydraulic system 114 by opening or closing one or more metering valves, such as metering valves 188, 164, 184, 194, and 302. As shown and described further below, the metering valve 302 may be configured as a pump bypass valve 302. Each of the metering valves 188, 164, 184, 194, and 302 may include a solenoid element. In accordance with the illustrated aspect, the metering valve 188 includes a solenoid element 189, the metering valve 164 includes a solenoid element 165, the metering valve 184 includes a solenoid element 185, and the bypass valve 302 includes a solenoid element 303. Each solenoid element may be coupled to the control module 112. An electronic signal from the control module 112 may be received by one or more of the solenoid elements, which may cause the one or more solenoid elements to energize. When solenoid elements are energized, the respective valves may be caused to open (or close), allowing (or preventing) fluid to pass through. Signals from the control module 112 to the various solenoid elements, and thus to various metering valves, may be generated in response to operator input or in response to various pressures within the hydraulic system 114 being above various thresholds, as determined by the control module 112.

The hydraulic system 114 may include pilot conduits and drain conduits (not shown) connecting to one or more of the metering valves and/or one or more of the solenoid elements. The pilot conduits and drain conduits may assist in the operation of the one or more of the metering valves and/or one or more of the solenoid elements. For example, upon actuation of a solenoid element, the pilot valve mechanism associated with the metering valve may be magnetically repelled from the solenoid element, allowing the metering valve to one of open or close.

In a first exemplary configuration, the cylinder 99 can be moved, for instance extended, by opening metering valves 164 and 194 and keeping metering valves 188 and 184 closed. In the first configuration, the pump 196 can supply pressurized fluid to conduit 161. In an exemplary aspect, the pump 196 is electronically controlled by the control module 112, although it will be understood that the pump 196 may be alternatively controlled as desired. In one exemplary aspect, the system 114 may include a warm-up valve 304. In the first configuration, the warm-up valve 304 may be closed such that the fluid flows to a check valve 168 via fluid conduits 161 and 162. The fluid can flow from the pump 196 through fluid conduits 161 and 162, and up to one or more check valves, such as the check valves 168. Once the fluid pressure builds to a predetermined level, the check valve 168 may be pushed open such that fluid flows through the open metering valve 164 to fluid conduit 170 to fill the head-end chamber 136. The metering valve 164 may be caused to open by the control module 112, via the operator input device 110 for example. The fluid in the head-end chamber 136 can cause the cylinder 99 to extend. Further, in the first configuration, the control module 112 can cause the independent metering valve 194 to open such that fluid flows from the rod-end chamber 140, over fluid conduit 180, and through the open metering valve 194. The fluid may flow through the open metering valve 194 to fluid conduit 205, to fluid conduit 206, and thus to the tank 156. Thus, in the first exemplary configuration, fluid in the rod-end chamber 140 may be decreased and fluid in the head-end chamber 136 may be increased to extend the cylinder 99.

In a second exemplary configuration, the cylinder 99 can be moved, for instance retracted, by opening metering valves 184 and 188 and keeping metering valves 164 and 194 closed. In the second configuration, the pump 196 can supply pressurized fluid to fluid conduit 161. In the second configuration, the warm-up valve 304 may be closed such that the fluid flows to the check valve 168 via fluid conduits 161 and 162. The warm-up valve 304 may include a solenoid element 305 that is coupled to the control module 112 such that the control module 112 can electronically control the warm-up valve 304. The fluid can flow from the pump 196 through fluid conduits 161 and 162, and up to one or more check valves, such as the check valves 168. Once the fluid pressure builds to a predetermined level, the check valve 168 may be pushed open such that fluid flows through the open metering valve 184 to fluid conduit 180 to fill the rod-end chamber 140. The metering valve 184 may be caused to open by the control module 112, via the operator input device 110 for example. The fluid in the rod-end chamber 140 can cause the cylinder 99 to retract. Further, in the second exemplary configuration, the control module 112 can cause the metering valve 188 to open such that fluid flows from the head-end chamber 136, over fluid conduit 170, and through the open metering valve 188. The fluid may flow through the open metering valve 188 to fluid conduit 171, to fluid conduit 206, and thus to the tank 156. Thus, in the second exemplary configuration, fluid in the head-end chamber 136 may be decreased and fluid in the rod-end chamber 140 may be increased to retract the cylinder 99.

The warm-up valve 304 may be opened, by the control module 112, during initial operation of the machine 100 with the metering valve 164 closed, the metering valve 184 closed, the metering valve 188 closed, and the metering valve 194 closed in order to move hydraulic fluid from the pumps 196 through conduit 161, through conduit 162, through conduit 205, through conduit 206, and into tanks 156 in order to increase the temperature of the hydraulic fluid within the system.

In an exemplary aspect, when a force on the cylinder 99, and in particular the rod 132, is greater than a threshold as determined by the control module 112, the control module 112 causes fluid to flow in the hydraulic system 100 such that the force on the rod 132 is decreased below the threshold. In these instances, the control module 112 might not receive an input from the operator input device 110 to fluidly fill or drain the cylinder 99, so the control module 112 can monitor the cylinder 99 to increase or decrease hydraulic fluid in the head-end chamber 136 or the rod-end chamber 140 as necessary. A given force on the cylinder 99 that is greater than a respective threshold can be a compression force in which the force is along a first direction D₁ defined from the head-end 136 toward the rod-end 140, or the given force on the cylinder 99 that is greater than a respective threshold can be a tension force in which the force is defined in a second direction D₂ defined from the rod-end 140 toward the head-end 136. Thus, a tension force on the rod 132 can be in a direction opposite the compression force on the rod 132. Further, the control module 112 can be configured to determine the threshold based on whether the force on the cylinder 99 is a tension force or a compression force. As further described below, the control module 112 can also be configured to determine the threshold based on a machine state of the mining shovel 100. In some instances, the threshold varies based on which activity the mining shovel 100 is performing when the force applied to the cylinder 99. Compression and tension forces may be caused by an external force, such as an external force on the dipper 108 for example.

With continuing reference to FIG. 2, in accordance with the illustrated aspect, the hydraulic system 114 includes a sensor assembly that includes one or more sensors, for instance first and second pressure sensors 158 and 159. In an exemplary aspect, the first sensor 158 can monitor the fluid pressure within the head-end chamber 136, and the second sensor 159 can monitor the fluid pressure within the rod-end 140 of the hydraulic cylinder 99. In an exemplary aspect, the sensors 159 and 158 are located at or near the rod-end chamber 140 and the head-end chamber 136 of the hydraulic cylinder 99. The sensors 158 and 159 may also be mounted within work ports of one or more valves within the hydraulic system 114, within one or more of the ports 146 and 148 of the hydraulic cylinder 99, or at or near the hydraulic pump 196. In accordance with the illustrated aspect, a third sensor 204 may be located near the pump 196. In some aspects, the hydraulic system 114 includes a single sensor that monitors the fluid pressure of the rod-end chamber 140 and the head-end chamber 136. The control module 112 can be operatively coupled to the sensors 158, 159, and 204 such that the control module can receive pressure readings that the sensors 158, 159, and 204 measure. Thus, the control module 112 can monitor a pressure at the rod-end chamber 140 and a pressure at the head-end chamber 136. Based on the monitored pressure at the rod-end chamber 140, the control module 112 can determine a rod-end force along the second direction D₂ as being equal to the product of the monitored (measured) pressure at the rod-end chamber 140 and the area of the second face 142 of the piston assembly 130. Similarly, based on the monitored pressure at the head-end chamber 136, the control module 112 can determine a head-end force along the first direction D₁ as being equal to the product of the monitored pressure at the head-end chamber 136 and the area of the first face 138 of the piston assembly 130. Various attributes of the hydraulic cylinder 99, such as the surface area of the first face 138 and the surface area of the second face 142 for example, can be stored at the control module 112 or otherwise configurable such that the control module 112 can access the various attributes.

The IMV assembly 116 may include the metering valves 164 that fluidly connect the hydraulic pump 196 to the head-end chamber 136 of the cylinder 99. When the fluid pressure in the head-end 136 is below a fluid pressure threshold, as measured by the first sensor 158, the control module 112 may route pressurized hydraulic fluid from the pump 196 to the head-end 136 by increasing the opening of the valves 164. In an exemplary aspect, the control module 112 causes the valves 164 to open and close to varying degrees, allowing a larger or smaller amount of fluid to pass through the valves 164. In this aspect, the valves 164 may have an infinite number of open positions between the fully open and fully closed. A valve being in a fully open position may refer to a valve that is open such that a maximum amount of fluid passes through it, and a valve being in a fully closed position may refer to a valve that is closed such that no fluid or a minimum amount of fluid is allowed to pass through the valve. In other aspects, the valve 164 is configured to move discretely between the fully open and the fully closed positions.

In an exemplary aspect, the control module 112 can open the valve 194 to decrease the tension force along the second direction D₂. When the control module 112 opens the valve 194, fluid can be permitted to flow from the rod-end 140, through the conduit 180 and the valve 194, to conduits 205 and 206 to the tank 156. Once the fluid pressure within the rod-end 140 decreases below a fluid pressure threshold, the control module 112 may cause the opening of the valve 194 to be reduced partially or fully blocking the fluid pathway from the rod-end 140 to the tank 156.

In an exemplary aspect, the control module 112 can open the valve 188 to decrease the compression force along the first direction D₁. When the control module 112 opens the valve 188, fluid can be permitted to flow from the head-end 136, through the conduit 170 and the valve 188, to conduits 171 and 206 to the tank 156. Once the fluid pressure within the head-end 136 decreases below a fluid pressure threshold, the control module 112 may cause the opening of the valve 188 to be reduced partially or fully blocking the fluid pathway from the head-end 136 to the tank 156.

The IMV assembly 116 can also include one or more makeup valves, such as first and second makeup valves 221 and 223, that are positioned within the IMV arrangement 118. The makeup valves 221 and 223 may provide hydraulic fluid to the head-end chamber 136 or the rod-end chamber 140 when pressure is below a threshold in the corresponding head-end 136 or rod-end 140. The makeup valves 221 and 223 are shown in FIG. 2 according to an exemplary aspect, but it will be understood that alternative aspects may include an alternative number of makeup valves positioned within the IMV assembly 116 as desired. The makeup valves 221 and 223 may also be associated with mechanical relief valves, and thus may also be referred to as first and second mechanical relief valves. In an exemplary aspect, the mechanical relief valve 220 can be configured to open when the pressure at the head-end 136 reaches a second pressure threshold that is greater than a first pressure threshold for opening the metering valve 188. Thus, fluid can be permitted to flow from the head-end 136 over conduit 170, and through the mechanical relief valve 220 to the tank 156, via conduits 170, 171, and 206. In another exemplary aspect, the mechanical relief valve 222 can be configured to open when the pressure at the rod-end 140 reaches a second pressure threshold that is greater than a first pressure threshold for opening the metering valve 194. Thus, fluid can be permitted to flow from the rod-end 140 over conduit 180, and through the mechanical relief valve 222 to the tank 156, via conduits 205 and 206. For example, the relief valves 220 and 222 can be configured to open when pressure within the IMV assembly 116 reaches a pressure threshold at which the IMV assembly 116 or its components are at risk for damage.

In accordance with an exemplary scenario in which the mining shovel 100 is in a digging state, the actuator 198 of the hydraulic cylinder 99 can be extended by the weight of the dipper 108, rather than in response to an input from the operator input device 110. Thus, an external force can be applied to the mining shovel 100 that can result in a tension force being applied to the cylinder 99. For example, the control module 112 can determine that the tension force along the second direction D₂ is greater than a threshold that is determined by the control module 112 based on the state (e.g., digging) of the mining shovel 100. As the actuator 198 is extended, for example due to an external force, a volume of the head-end chamber 136 can be increased. Thus, a volume of the rod-end chamber 140 can be decreased, which can increase a pressure at the rod-end 140. The control module 112 can determine that the pressure at the rod-end 140 is greater than a threshold. In response to the determination, the control module 112 can cause metering valve 194 to open, thereby metering the flow out of the rod-end 140 of the cylinder 99 such that the pressure at the rod-end 140 returns below the threshold. In an exemplary aspect, the control module 112 causes the valve 194 to open and close to varying degrees, allowing a larger or smaller amount of fluid to pass through the valve 194. In this aspect, the valve 194 can have an infinite number open positions between the fully open position and the fully closed position. In some other aspects, the valve 194 can be configured to move discretely between the fully open and the fully closed positions. Additionally, or alternatively, the control module 112 causes the valve 164 to open, routing hydraulic fluid from the pump 196 to the head-end 136 of the cylinder 99 to decrease the tension force along the second direction D₂ until pressure at the rod-end 140 is below the threshold.

Thus, in accordance with an exemplary aspect, the control module 112 may cause the metering valve 194 to open. For example, the control module 112 can determine that the pressure at the rod-end 140 is greater than a threshold. In response to this determination, the control module 112 can open the valve 194 so that fluid is routed from the rod-end chamber 140 into the IMV assembly 116. The fluid can be routed from the rod-end 140 through the open valves 194, and then through the fluid path 206, and outside of the IMV assembly 116 to the hydraulic tank 156 for re-use. Thus, the control module 112 can be operatively coupled to the sensor 159 that is configured to measure a pressure at the rod-end 140 of the cylinder 99. The control module 112 can be configured to selectively open the valve 194 when the pressure at the rod-end 140 of the cylinder 99 reaches a first pressure threshold, to permit fluid to flow from the rod-end 140 of the cylinder 99 to the tank 156.

In accordance with an exemplary scenario in which the mining shovel 100 is in a digging state, the actuator 198 of the hydraulic cylinder 99 can be retracted by the weight of the dipper 108, rather than in response to an input from the operator input device 110. Thus, an external force can be applied to the mining shovel 100 that results in a compression force being applied to the cylinder 99. For example, the control module 112 can determine that the compression force along the first direction is greater than a threshold that is determined by the control module 112 based on the state (e.g., digging) of the mining shovel 100. When the control module 112 determines that the fluid pressure in the head-end chamber 136 is above a threshold, as measured by the sensors 158, the control module 112 can cause the openings of the valve 188 to increase. Thus, fluid can be pushed from the head-end chamber 136 of the cylinder 99 to decrease the pressure at the head-end 136, and thus decrease the compression force along the first direction. The pushed fluid can flow through fluid conduit 170, and through the open valve 188. The fluid can further be permitted through fluid conduits 171 and 206, and then to the tank 156. Thus, the control module 112 can be operatively coupled to at least one sensor 158 that is configured to measure a pressure at the head-end 136 of the cylinder 99. The control module 112 can be configured to selectively open one the valve 188 when the pressure at the head-end 136 of the cylinder 99 reaches a first pressure threshold, to permit fluid to flow from the head-end 136 of the cylinder 99 to the tank 156.

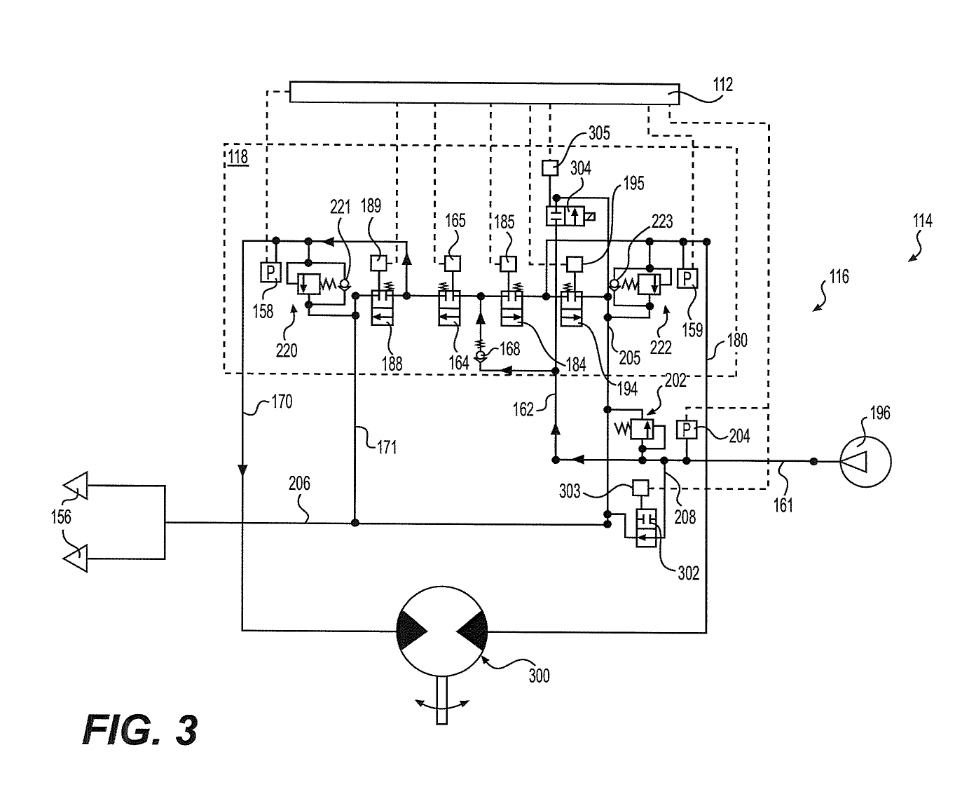

Referring still to FIG. 2, the IMV assembly 116 can further include a third mechanical relief valve 202 and the pump bypass valve 302. The pump bypass valve 302 may include a solenoid element 303 that is coupled to the control module 112. The mechanical relief valve 202 and the pump bypass valve 302 may be fluidly connected to the tank 156. The mechanical relief valve 202 can be configured to open when the pressure at the pump 196, that is measured by a third sensor 204, reaches a second pressure threshold that is greater than a pressure threshold for opening the pump bypass valve 302. For example, the relief valve 202 can be configured to open when pressure within the IMV assembly 116 reaches a pressure threshold at which the IMV assembly 116 or its components are at risk for damage. In accordance with the illustrated aspect, when the relief valve 202 opens, fluid can pass through the valve 202, through the fluid path 206 to the hydraulic tank 156. Further, in accordance with the illustrated aspect, when the pump bypass valve 302 opens, fluid can pass through a pump bypass line 208, and through the fluid conduit 206 to the tank 156. Thus, the bypass valve 302 can be closed to move the cylinder 99, in accordance with an exemplary aspect. In an alternative exemplary aspect, the system 114 may not include the bypass valve 302, and thus the cylinder 99 can move without a bypass valve being closed. The pump bypass line 208 can divert fluid to the tank to circulate oil and prevent a high standby pressure within the system 114. The fluid pressure within the system 114 can be measured by the third pressure sensor 204 that can be located near the hydraulic pump 196. It should be appreciated that the metering valves (e.g. valves 188, 164, 184, 194, etc.) that are shown in FIGS. 2-3 and described above may be any types of valves configured to route fluid throughout the hydraulic system 114. For instance, the valves may be spool valves, poppet valves, servo valves, or the like.

In an exemplary aspect, the control module may be further configured to control the valves during boom jacking such that the mining shovel 100 is protected from damage. Boom jacking may refer to a situation in which the ropes 103 lose tension such that the ropes 103 are slack. For example, during operation, the cylinder 99 can be extended such that the dipper 108 applies a force to the ground or the face of mining material. In response to the force that the dipper 108 applies, an opposite force may be applied on the cylinder 99. For example, a compression force may be applied on the cylinder 99, and such a force may cause the boom 101 to rotate away from the dipper 108 such that the boom 101 is in a boom jacking position, which may cause the ropes 103 to lose tension. Thus, the tension on the ropes 103 during the boom jacking position may be less as compared to the tension on the ropes 103 when the boom 101 is in a normal position. The control module 112 can determine that the compression force along the first direction is greater than a threshold that is determined by the control module 112 based on the state (e.g., boom jacking) of the mining shovel 100. In an exemplary aspect, the control module 112 can detect the boom jacking position, and can control the forces on the cylinder 99, through the hydraulic system 114, in response to the boom jacking position such that the cylinder 99 is controlled to minimize stress on the mining shovel 100 as the boom 101 is returned to the normal position. Moreover, the extent and the effect of the boom jacking may be reduced.

In an exemplary aspect, one or more sensors may detect boom jacking by monitoring the tension on the ropes 103. The sensors may be coupled to the control module 112 so that the control module 112 may determine that the mining shovel 100 is in a boom jacking position by determining that the tension on the ropes 103 is below a predetermined threshold. In this regard, the sensors may be associated with the ropes 103 or other associated structure. The sensors may be load cells, strain gages, stress gauges, and the like to determine the boom and jacking position of the mining shovel 100. In another exemplary aspect, one or more angle sensors may detect boom jacking by monitoring an angle of the boom 101 relative to one more structures of the mining shovel 100. The one or more angle sensors may be coupled to the control module 112 so that the control module 112 may determine that the mining shovel 100 is in a boom jacking position by determining that the angle of the boom 101 relative to the one or more structures is greater or less than respective thresholds.

When the control module 112 determines that the mining shovel 100 is in the boom jacking position, the control module 112 may control a rate at which the boom 101 is lowered to the ground by monitoring the force on the rod 132. For example, the control module 112 may put the mining shovel 100 into an override mode such that the operator cannot control the dipper assembly 104 via the operator input device 110. When the mining shovel is in the boom jacking position, the control module 112 may monitor and control the valve assembly 116, and in particular the pressure at the head-end 136, so that the cylinder 99 is retracted at a controlled rate, thereby returning the boom 101 to the normal position at a controlled rate. When the boom 101 returns to the normal position, as determined by the control module 112, the control module 112 may return the mining shovel to operator control such that the operator can again control the dipper assembly 104 via the operator input device 110. In an exemplary aspect, if the control module 112 does not control the pressure at the head-end 136 at a controlled rate when the mining shovel 100 is in the boom jacking position, the boom 101 may fall back into the normal position at a free-fall rate, which may be greater than desired and may cause the structural integrity of the mining shovel 100 to decrease over time or the like.

In another exemplary aspect, the control module 112 may be further configured to control the valves during dipper propelling such that the mining shovel 100 is protected from damage. Dipper propelling may refer to a situation in which dipper assembly 104, and in particular the dipper arm 106, is parallel to the ground while the bucket 108 is propelled into a face of mining material, such as a wall or bank for example. This action may apply a compression force on the rod 132, as described above. Such a force during dipper propelling may cause the boom assembly 102 to flip backward away from the mining material or otherwise damage one of the components. The control module 112 may determine whether the compression force is greater than a predetermined threshold. For example, the control module 112 can determine that the compression force along the first direction is greater than a threshold that is determined by the control module 112 based on the state (e.g., dipper propelling) of the mining shovel 100. The predetermined threshold is based on the operation (state) of the mining shovel 100. In an exemplary aspect, the predetermined threshold associated with the mining shovel being in a dipper propelling operation may be less than the predetermined threshold associated with the mining shovel being in a boom jacking operation. In an exemplary aspect, the control module 112 can detect the dipper propelling operation, can determine that the compression force is greater than a predetermined threshold associated with the dipper propelling operation, and can control the forces on the cylinder 99, through the hydraulic system 114, in response to the determination such that the cylinder 99 is controlled to minimize stress on the boom assembly 102 as it is returned to the normal position. By way of further example, if the boom assembly 102 is pushed backward as a result of dipper propelling and the ropes 103 are slacked, the bank or wall of the mining material may collapse, and the boom assembly 102 can crash downward because the earth is no longer supporting its weight, which may result in damage. Thus, controlling the rate at which the boom assembly is returned may reduce damage that may result from dipper propelling when the compression forces exceed a threshold.

The construction and arrangements of the hydraulic system 114, as shown in the various exemplary aspects, are illustrative only. Although only a few aspects have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative aspects. Other substitutions, modifications, changes and omissions may also be made in the design, operating conditions and arrangement of the various exemplary aspects without departing from the scope of the present disclosure.

FIG. 3 is a schematic view of the hydraulic system 114 that may include one or more hydraulically actuator motors, such as a motor 300 for example. Referring to FIG. 3, in accordance with another exemplary aspect, the control module 112 may be configured to monitor and control a torque on the motor 300, which may be referred to as a motor torque. The IMV assembly 116 may be hydraulically coupled to the motor 300 instead of the cylinder 99. To control the torque on the motor, one or more sensors, for example the sensor 158, may monitor the hydraulic pressure applied to the motor 300 from the pump 196. The control module 112 may be electronically coupled to the sensor 158 such that the control module 112 may compute the torque from the pressure and the motor's displacement per revolution. In an exemplary aspect, the control module 112 may be configured with various parameters of the motor 300, such as the displacement per revolution. Alternatively, the control module 112 can electronically measure the displacement per revolution. The control module 112 can control the torque by metering the pressure that goes into the valve via the IMV assembly 116, as described above. Further, it will be appreciated that the control module 112 may be configured with various torque thresholds based on operating conditions of the motor 300. Further still, the control module 112 may be configured with various thresholds that correspond to a variety of motors such that the control module 112 may be compatible with a variety of motors.

### INDUSTRIAL APPLICABILITY

The present disclosure is applicable to hydraulic systems on work machines, and more specifically to hydraulic systems on mining shovels. Mining shovels are configured to load, excavate, and transport mining material. As part of the operations, compression and tension forces can be placed on the cylinder 99 within the hydraulic system 114. Such forces can create pressures within the rod-end chamber 140 or the head-end chamber 136 that are above threshold levels. The control module 112 can determine various threshold levels based on the operation of the mining shovel 100, and based on whether the pressure is at the rod-end 140 or the head-end 136. When a pressure is above a respective threshold, the control module 112 can open various configurations of valves in the IMV assembly 116 to reduce pressure levels. Valves in the IMV assembly 116 may be independently opened by the control module 112 to reduce pressures at lower pressure thresholds than a pressure threshold at which the mechanical relief valves are caused to open. Thus, mechanical relief valves in the hydraulic system 114 can be preserved because they are actuated less as compared to a system without the IMV assembly 116. Further, the mechanical relief valves still protect the hydraulic system from high pressure conditions. Further still, the control module 112 allows IMV assembly 116 to provide tailored responses based on various forces that are on induced on the cylinder 99, as it is recognized that the cylinder 99 can withstand different thresholds during different machine operations. Additionally, the control module 112 may be configured to control the IMV assembly 116 based on the cylinder that is being monitored. For instance, various cylinders may have different force thresholds that each of the cylinders can withstand, and the control module 112 may be configured to control various cylinders having various force thresholds. Thus, the control module 112 may be compatible with a variety of hydraulic systems having various configurations of cylinders.

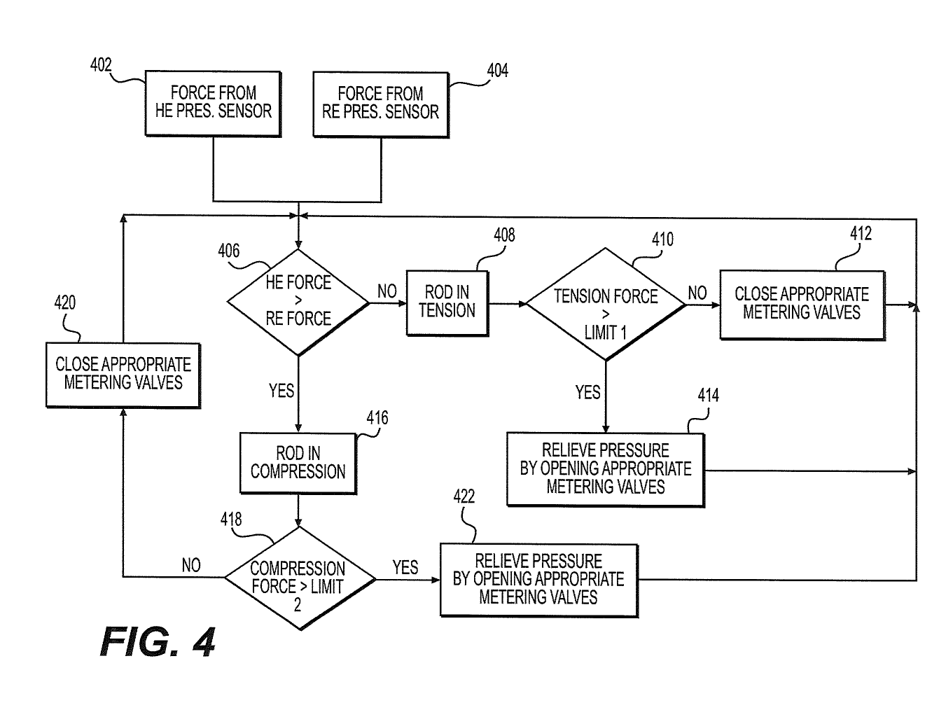

FIG. 4 is a flow diagram that illustrates a method that may be performed by the machine depicted in FIG. 1 in accordance with an exemplary aspect of this disclosure. Referring to FIG. 4, at 402, the control module 112 may determine a head-end force from a head-end pressure. As described above, the head-end pressure may be monitored by one or more sensors, such as the sensor 158. The control module 112 may determine the head-end force based on the pressure at the head-end 136 and the area of the first face 138. At 404, the control module may 112 may determine a rod-end force from a rod-end pressure. As described above, the rod-end pressure may be monitored by one or more sensors, such as the sensor 159. The control module 112 may determine the rod-end force based on the pressure at the rod-end 140 and the area of the second face 142. At 406, the control module 112 may compare the rod-end force to the head-end force. If the rod-end force is greater than the head-end force, the control module 112 may determine that that a tension force is being applied to the rod 132, at 408. At 410, the control module 112 may compare the tension force to a first limit or threshold, which may also be referred to as a tension threshold. As described above, the limit or threshold may be based on characteristics of the cylinder 99, the state of the machine 100, or the like. If the tension force is less than or equal to the tension threshold, the process may proceed to step 412, where one or more appropriate metering valves are closed by the control module 112. If the tension force is greater than the threshold, the process may proceed to step 414, where the pressure at the rod-end 140 is relieved by opening one or more appropriate metering valves until the tension force decreases below the tension threshold. After and/or during 412 and 414, pressures may continue to be monitored by one or more sensors, and the control module 112 may continue to compare the head-end force to the rod-end force, at 406.

If the head-end force is greater than the rod-end force, the control module 112 may determine that a compression force is being applied to the rod 132, at 416. At 418, the control module 112 may compare the compression force to a second limit or threshold, which may also be referred to as a compression threshold. As described above, the second limit or threshold may be based on characteristics of the cylinder 99, the state of the machine 100, or the like. If the compression force is less than or equal to the compression threshold, the process may proceed to step 420, where one or more appropriate metering valves are closed by the control module 112. If the compression force is greater than the compression threshold, the process may proceed to step 422, where the pressure at the rod-end 140 is relieved by opening one or more appropriate metering valves until the compression force decreases below the compression threshold. After and/or during 420 and 422, pressures may continue to be monitored by one or more sensors, and the control module 112 may continue to compare the head-end force to the rod-end force, at 406.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A hydraulic system comprising:
a cylinder having a first end and a second end opposite the first end, the cylinder being movable between a retracted position and an extended position;
a hydraulic pump hydraulically connected to at least the first end of the cylinder to facilitate movement of the cylinder;
a first mechanical relief valve hydraulically connected to the first end of the cylinder;
a first valve hydraulically connected to the first end of the cylinder and a tank;
a first sensor configured to measure a pressure at the first end of the cylinder; and
a control module operatively coupled to the first sensor and the first valve, the control module being configured to selectively open the first valve when the pressure at the first end of the cylinder reaches a first pressure threshold, to permit fluid to flow from the first end of the cylinder to the tank.

2. The hydraulic system of claim 1, wherein the first mechanical relief valve is configured to open when the pressure at the first end of the cylinder reaches a second pressure threshold, to permit fluid to flow from the first end of the cylinder to the tank, the second pressure threshold being greater than the first pressure threshold.

3. The hydraulic system of claim 1, wherein the control module is configured to determine the first pressure threshold based on whether the first end is a rod-end or a head-end.

4. The hydraulic system of claim 1, further comprising:
a second valve hydraulically connected to the hydraulic pump and the second end of the cylinder, wherein the control module is further operatively coupled to the second valve, and wherein the control module is further configured to selectively open the valve when the pressure at the first end of the cylinder reaches the first pressure threshold, to permit fluid to flow from the pump to the second end.

5. The hydraulic system of claim 1, further comprising:
a third valve hydraulically connected to the second end of the cylinder and the tank; and
a second sensor configured to measure a pressure at the second end of the cylinder,
wherein the control module is further operatively coupled to the second sensor and the valve; the control module being further configured to selectively open the third valve when the pressure at the second end of the cylinder reaches a third pressure threshold, to permit fluid to flow from the second end of the cylinder to the tank.

6. The hydraulic system of claim 5, further comprising:
a second mechanical relief valve hydraulically connected to the second end of the cylinder; and
the second mechanical relief valve being configured to open when the pressure at the second end of the cylinder reaches a fourth pressure threshold, to permit fluid to flow from the second end of the cylinder to the tank, the fourth pressure threshold being greater than the third pressure threshold.

7. The hydraulic system of claim 5, wherein the control module is further configured to determine the third pressure threshold based on whether the second end is a rod end or a head end.

8. The hydraulic system of claim 5, further comprising:
a fourth valve hydraulically connected to the pump and the second end of the cylinder, wherein the control module is further operatively coupled to the fourth valve, and wherein the control module is further configured to selectively open the fourth valve when the pressure at the second end of the cylinder reaches the first pressure threshold, to permit fluid to flow from the pump to the first end.

9. The hydraulic system of claim 1, wherein one of the first and second ends is a rod-end, and the other of the first and second ends is a head-end.

10. A work machine comprising the hydraulic system of claim 1, further comprising:
a boom assembly;
a dipper movably connected to the boom assembly; and
the cylinder operably connected to the dipper.

11. The hydraulic system of claim 1, wherein the control module is configured to determine the first pressure threshold based on whether a tension force or a compression force is applied to the cylinder.

12. The hydraulic system of claim 11, wherein the control module is configured to determine whether the tension force or the compression force exceeds a force threshold, and wherein the control module is further configured to determine the force threshold based on a state of the work machine.

13. A method of operating a hydraulic system that includes 1) a hydraulic cylinder having a first end and a second end opposite the first end, the cylinder being movable between a retracted position and an extended position; 2) a hydraulic pump selectively hydraulically connected to at least the first end of the cylinder to facilitate movement of the hydraulic cylinder; 3) a first mechanical relief valve hydraulically connected to the first end of the cylinder; 4) a first valve hydraulically connected to the first end of the cylinder and a tank; 5) a first sensor configured to measure a pressure at the first end of the cylinder; and 6) a control module operatively coupled to the first sensor and the first valve, the method comprising:
determining with the first sensor that the pressure at the first end of the cylinder exceeds a first pressure threshold; and
opening the first valve such that fluid flows from the first end of the cylinder to the tank.

14. The method of claim 13, the method further comprising:
configuring the first mechanical relief valve such that when the pressure at the first end of the cylinder reaches a second pressure threshold, fluid flows from the first end of the cylinder to the tank, the second pressure threshold being greater than the first pressure threshold.

15. The method of claim 13, the method further comprising:
determining the first pressure threshold based on whether the first end is a rod-end or a head-end of the cylinder.

16. The method of claim 13, wherein the hydraulic system further includes a second valve hydraulically connected to the hydraulic pump and the second end of the cylinder, the method further comprising:
opening the second valve such that fluid flows from the pump to the second end in response to the determining.

17. The method of claim 13, wherein the hydraulic system further includes a third valve hydraulically connected to the second end of the cylinder and the tank, and a second sensor configured to measure a pressure at the second end of the cylinder, the method further comprising:
determining that the pressure at the second end of the cylinder exceeds a third pressure threshold; and
opening the third valve such that fluid flows from the second end of the cylinder to the tank.

18. The method of claim 17, wherein the hydraulic system further includes a second mechanical relief valve hydraulically connected to the second end of the cylinder, the method further comprising:
configuring the second mechanical relief valve such that when the pressure at the second end of the cylinder reaches a fourth pressure threshold, fluid flows from the second end of the cylinder to the tank, the fourth pressure threshold being greater than the third pressure threshold.

19. The method of claim 17, the method further comprising determining the third pressure threshold based on whether the second end is a rod-end or a head end of the cylinder.

20. The method of claim 17, wherein the hydraulic system further includes a fourth valve hydraulically connected to the pump and the second end of the cylinder, the method further comprising:
opening the fourth valve such that fluid flows from the pump to the first end.

21. The method of claim 13, wherein one of the first and second ends is a head-end, and the other of the first and second ends is a rod-end.

22. A hydraulic system comprising:
a hydraulic actuation device having a first input and a second input, the hydraulic actuation device being movable in response to fluid being applied to the first input or the second input;
a hydraulic pump hydraulically connected to at least the first input of the hydraulic actuation device to facilitate movement of the hydraulic actuation device;
a first mechanical relief valve hydraulically connected to the first input of the hydraulic actuation device;
a first valve hydraulically connected to the first input of the hydraulic actuation device and a tank;
a first sensor configured to measure a pressure at the first input of the hydraulic actuation device; and
a control module operatively coupled to the first sensor and the first valve, the control module being configured to selectively open the first valve when the pressure at the first input of the hydraulic actuation device reaches a first pressure threshold, to permit fluid to flow from the first input of the hydraulic actuation device to the tank.
